(19) United States
(12) Patent Application Publication
(10) Pub. No.: US 2003/0201346 A1
(43) Pub. Date: Oct. 30, 2003

(54) Fuel injection valve

(76) Inventors: Yukinori Kato, Obu-shi (JP); Hikaru Kikuta, Obu-shi (JP)

Correspondence Address: BAKER & BOTTS, 30 ROCKEFELLER PLAZA, NEW YORK, NY, 10112

(21) Appl. No.: 10/420,606

(22) Filed: Apr. 22, 2003

(30) Foreign Application Priority Data
Apr. 24, 2002 (JP) 2002-160736

(51) Int. Cl. B05B 1/30

(52) U.S. Cl. 239/585.1

(57) ABSTRACT

A low-cost and compact fuel injection valve that requires a minimum number of man-hours for production and that allows repair of a flaw or a pinhole in an insulating coating is provided. The fuel injection valve has an electromagnetic coil using an insulated coil wire covered with an insulating coating and having a fusion bonding layer with self-fusing properties coated over the insulating coating. Therefore, it is possible to dispense with the use of a bobbin and hence possible to provide a low-cost and compact fuel injection valve that requires a reduced number of man-hours for production. Further, a flaw or a pinhole in the insulating coating is repaired by self-fusion, and thus insulation properties and waterproofness are improved. Accordingly, it is possible to prevent disconnection of the coil due to electrolytic corrosion.

### BACKGROUND OF THE INVENTION

1. Field of the Invention

The present invention relates to a fuel injection valve for use in an internal-combustion engine. More particularly, the present invention relates to a low-cost and compact fuel injection valve that allows repair of a defect in the coil and that requires a reduced number of man-hours for production.

2. Discussion of Related Art

A conventional fuel injection valve has an electromagnetic coil formed by winding a coil wire around a stationary core constituting the fuel injection valve. In this conventional fuel injection valve, as shown in FIG. 2, a bobbin 32 made of a synthetic resin material is disposed between a stationary core 30 and a coil wire 31 to ensure insulation therebetween. Insulation between the turns of the coil wire 31 is ensured by an insulating coating applied to the surface of the coil wire 31.

### SUMMARY OF THE INVENTION

Recently, there has been a strong demand owing to modularization of automotive parts that a fuel injection valve and other engine parts should be made compact. Meanwhile, a flaw or a pinhole in the coil insulating coating may cause electrolytic corrosion by water entering the coil part of the fuel injection valve, which may lead to disconnection of the coil. This is a problem to be solved before shipment of the products.

Accordingly, an object of the present invention is to provide a low-cost and compact fuel injection valve that requires a minimum number of man-hours for production, and also provide a fuel injection valve that allows repair of a flaw or a pinhole in the insulating coating.

To attain the above-described object, the present invention is applied to a fuel injection valve wherein an electromagnetic coil wound from a coil wire is disposed around the outer periphery of a stationary core. According to the present invention, the coil wire is an insulated wire covered with an insulating coating and having a fusion bonding layer with self-fusing properties coated over the insulating coating.

Preferably, the fusion bonding layer fuses to itself by self-heat generation during energization of the electromagnetic coil.

The present invention offers the following advantageous effects. The fuel injection valve according to the present invention has an electromagnetic coil using an insulated coil wire covered with an insulating coating and having a fusion bonding layer with self-fusing properties coated over the insulating coating. Therefore, it is possible to dispense with the use of a bobbin and hence possible to provide a low-cost and compact fuel injection valve that requires a reduced number of man-hours for production. Further, a flaw or a pinhole in the insulating coating is repaired by self-fusion, and thus insulation properties and waterproofness are improved. Accordingly, it is possible to prevent disconnection of the coil due to electrolytic corrosion. If the fusion bonding layer is allowed to fuse to itself by self-heat generation during energization of the electromagnetic coil, it becomes unnecessary to use a special heating apparatus. Accordingly, it is possible to provide a low-cost fuel injection valve that requires a reduced number of man-hours for production.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1A is a longitudinal sectional view of a fuel injection valve according to an embodiment of the present invention.

FIG. 1B is a sectional view of a coil according to the present invention.

FIG. 2 is a longitudinal sectional view of a conventional fuel injection valve.

### DESCRIPTION OF THE PREFERRED EMBODIMENTS

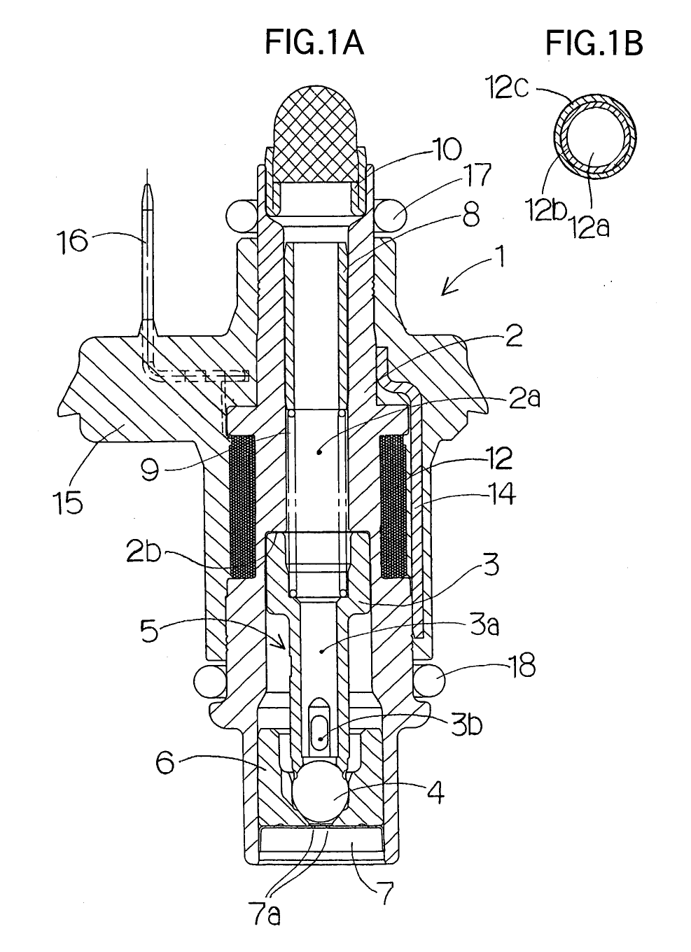

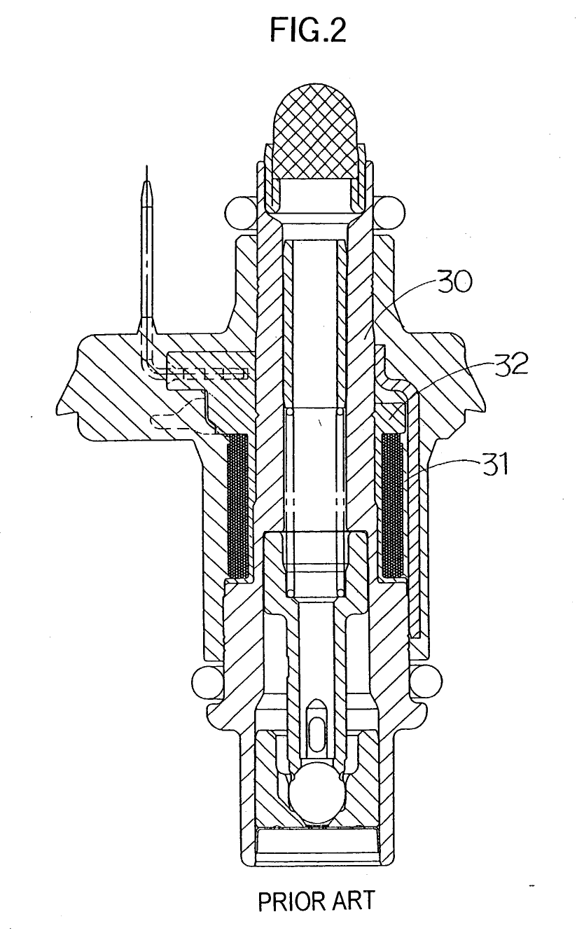

A preferred embodiment of the present invention will be described below with reference to the accompanying drawings. In FIGS. 1A and 1B, a fuel injection valve 1 includes a stationary core 2. The stationary core 2 has a fuel passage 2a provided in the center thereof. An armature (moving core) 3 is slidably disposed in the fuel passage 2a. A fuel passage 3a is provided in the center of the armature 3 to pass fuel. A ball valve 4 is secured to the distal end of the armature 3, for example, by welding to constitute a moving valve 5. A communicating hole 3b is provided in the armature 3 near the ball valve 4 to allow fuel to flow to the outside from the fuel passage 3a. A nozzle 7 is secured to the lower opening of the stationary core 2 by press fitting or welding. The nozzle 7 has a valve seat 6 and an injection port 7a. The moving valve 5 is arranged to move between the valve seat 6 and an abutting surface 2b of the stationary core 2 with an appropriate lift (gap). A cylindrical sleeve 8 is press-fit into the upper end portion of the fuel passage 2a. The lower end of the sleeve 8 retains the upper end of a spring 9 for pressing the moving valve 5 against the valve seat 6.

A filter 10 is press-fit into the upper opening of the stationary core 2. A coil 12 is wound around the outer periphery of the stationary core 2. One end of the coil 12 is connected to a terminal 16. The other end of the coil 12 is grounded. Thus, an electric signal is input through the terminal 16. The coil 12 uses a commercially available self-bonding insulated coil in which, as shown in FIG. 1B, an electric wire 12a is covered with an insulating coating 12b, and a fusion bonding layer 12c with self-fusing properties is coated over the insulating coating 12b. After both ends of the coil 12 have been connected to the terminal 16 and the grounding terminal, respectively, the coil 12 is subjected to fusion bonding process (described later) and then integrally resin-molded with a synthetic resin housing 15 with a yoke 14 provided therebetween. The upper end portion of the fuel injection valve 1 is connected to a delivery pipe through an O-ring 17. The lower end portion of the fuel injection valve 1 is connected to an intake manifold through an O-ring 18. Fuel flowing into the fuel injection valve 1 through the filter 10 is injected through the injection port 7a when the moving valve 5 is pushed up in response to the energization of the coil 12.

Next, the operation of this embodiment and the fusing treatment of the coil will be described. After the coil wire has been wound around the stationary core and connected to the terminal 16 and the grounding terminal, the coil is supplied with electric power to heat the fusion bonding layer. Thus, fusion bonding is performed. Regarding the supply of electric power, a voltage to be applied and a heating time are experimentally determined in advance so that the temperature of the fusion bonding layer is within the range of from 140 to 160° C. The fusion bonding layer fuses to close a possible flaw or pinhole in the insulating coating, thereby improving the insulation properties and waterproofness of the electric wire.

It should be noted that the present invention is not necessarily limited to the foregoing embodiment but can be modified in a variety of ways without departing from the gist of the present invention.

What is claimed is:

1. A fuel injection valve having an electromagnetic coil wound from a coil wire, said electromagnetic coil being disposed around an outer periphery of a stationary core,
wherein said coil wire is an insulated wire covered with an insulating coating and having a fusion bonding layer with self-fusing properties coated over said insulating coating.

2. A fuel injection valve according to claim 1, wherein said fusion bonding layer fuses to itself by self-heat generation during energization of said electromagnetic coil.
